(19) United States
(12) Patent Application Publication
(10) Pub. No.: US 2009/0069103 A1
(43) Pub. Date: Mar. 12, 2009

(54) PUNCH AND RELATED RECESSED SCREW

(75) Inventor: GUO-CAI SU, KAOHSIUNG CITY (TW)

Correspondence Address: ROSENBERG, KLEIN & LEE, 3458 ELLICOTT CENTER DRIVE-SUITE 101, ELLICOTT CITY, MD, 21043, US

(73) Assignee: TAIWAN SHAN YIN INT'L CO. LTD., KAOHSIUNG CITY (TW)

(21) Appl. No.: 11/851,710

(22) Filed: Sep. 7, 2007

(51) Int. Cl. B21K 1/46; B23G 9/00

(52) U.S. Cl. 470/63

(57) ABSTRACT

The present invention pertains to a punch for forming recessed screw comprising a punch body and a punch head. Particularly, the punch head includes two square portions having different heights and square sides and intersecting at an included angle, thereby punching the corresponding tiers of recesses in the socket of the screw head. In this manner, the screw can be facilely driven by a screwdriver presenting a square configuration or a uniform shape as the punch, which facilitates to reduce the problem of unfitted driving tool and increase the convenience while in operation.

### BACKGROUND OF THE INVENTION

1. Field of the Invention

The present invention relates to a punch and a recessed screw, in particular concerned with a punch including dual tiers of square portions for punching the corresponding tiers of recesses in the screw head, which is conducive to receive a screwdriver presenting a square shape or a configuration as the same as the punch.

2. Description of the Related Art

Referring to FIGS. 1 and 2, a conventional punch 1 of the U.S. Pat. No. 3,972,083 discloses a punch body 11 and a punch head 12 extended from the punch body 11 for punching a recess 211 in a screw head 21 of a screw 2; wherein, the punch head 12 presents in cross section eight symmetrically corners defined by any of two adjacent wall portions 12a and 12b, which intersect at a right angle as shown in FIG. 2. Any series of four alternate corners defines a square 121 in solid line and cross hatched, and the remaining series of four alternate corners defines another square 122 in dotted line.

While in punching, the punch shank 12 is set into the recess 211, which is formed by a single punch blow at room temperature and has a configuration corresponding to the punch 1 for the entrance of a square screwdriver.

From the above, although the recess 211 punched by the punch 1 receives the square screwdriver, there may be some defects. Due to the configuration of the punch head 12, a single tier of the recess 211 is accordingly formed, which may merely receive a simple square screwdriver, but may not be optimally seated by a square screwdriver with different dimensions. As a result, it may bring the inconvenience for the users while in operation.

### SUMMARY OF THE INVENTION

Therefore, the objects of the present invention are to provide a punch for punching a socket in a screw head, where dual tiers of the recesses are formed in accordance with the configurations of the square portions of the punch, thus improving the problem of unfitted driving tool and increase the convenience while using.

The punch for forming recessed screw related to the present invention comprises a punch body and a punch head; wherein, the punch body has a first square portion and a second square portion, and the first square portion is inclined with respect to the second square portion by an included angle; the height of the second square portion extended from the punch body exceeds that of the first square portion, and each of the series of square sides of the first square portion is greater than that of the second square portion, so as to form dual tiers of the recesses in the socket of the screw head. As a result, the present invention facilitates to decrease the problem of unfitted driving tool and increase the convenience in use.

The advantages of the present invention over the known prior art will become more apparent to those of ordinary skilled in the art upon reading the following descriptions in conjunction with the accompanying drawings.

### BRIEF DESCRIPTION OF THE DRAWINGS

FIG. 1 is a schematic view showing a conventional punch of U.S. Pat. No. 3,972,083 for forming a socket in a screw head;

FIG. 2 is a schematic view showing the outline in underside plan of the conventional punch of U.S. Pat. No. 3,972,083;

FIG. 3 is a perspective view showing a punch and a related recessed screw of the preferred embodiment of the present invention;

FIG. 4 is a top view showing the formation of the recessed screw punched by the punch of FIG. 3;

FIG. 5 is a schematic view showing a state of the punching of the preferred embodiment of the present invention that the punch of FIG. 3 punches a socket in the screw head;

FIG. 6 is a schematic view showing a screwdriver formed in conformity with the shape of the first square portion of the punch for promoting the screwdriver to accurately fit with the socket of the screw head

FIG. 7 is a schematic view showing a screwdriver formed in conformity with the shape of the second square portion of the punch for promoting the screwdriver to accurately fit with the socket of the screw head; and

FIG. 8 is a schematic view showing a screwdriver formed in conformity with a configuration of the entire punch head of the punch, thereby promoting the screwdriver to accurately fit with the socket of the screw head.

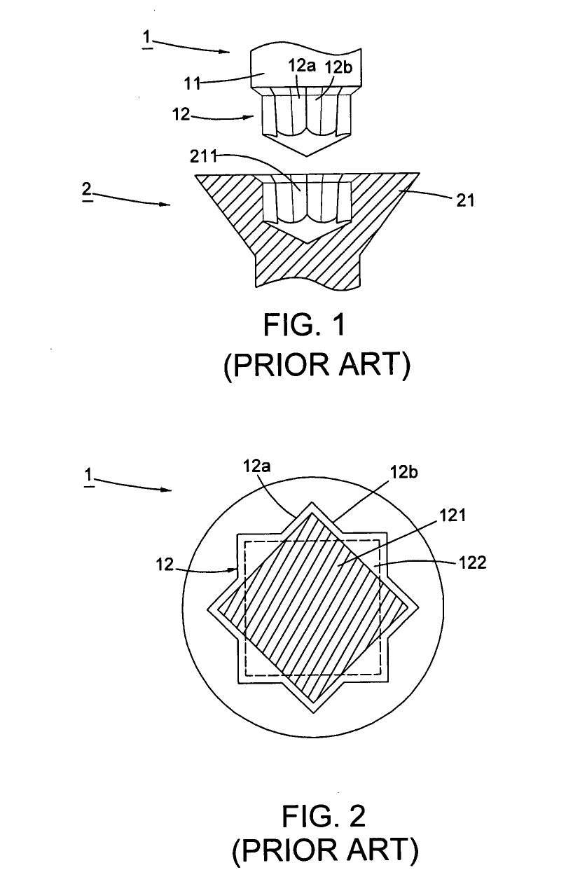

### DETAILED DESCRIPTION OF THE PREFERRED EMBODIMENTS

Before the present invention is described in greater detail, it should be noted that the similar elements are denoted by the same reference numerals throughout the disclosure.

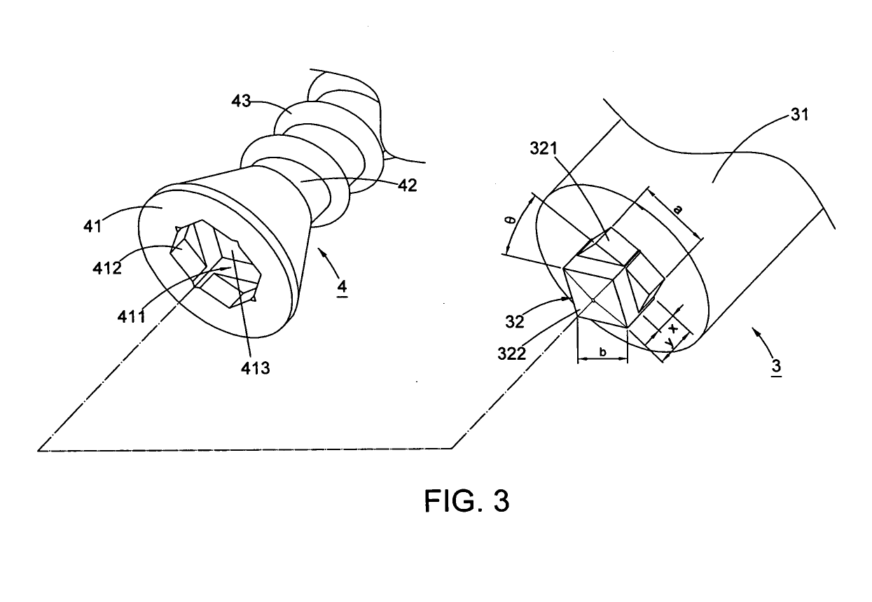

Referring to FIG. 3, a punch 3 for forming recessed screw 4 of the preferred embodiment of the present invention comprises a punch body 31 and a punch head 32 longitudinally extended from the punch body 31; wherein, the punch body 31 comprises a first square portion 321 and a second square portion 322 disposed on the first square portion 321; the first square portion 321 is inclined with respect to the second square portion 322 by an included angle “θ”, which is in 45 degrees and is adopted in the preferred embodiment of the present invention. Both of the square portions 321 and 322 have heights “x” and “y” extended from the punch body 31 and have two series of square sides “a” and “b” defined around the peripheries thereof, respectively. The height “y” of the second square portion 322 exceeds the height “x” of the first square portion 321; moreover, each of the series of square sides “a” of the first square portion 321 is greater than each of the series of square sides “b” of the second square portion 322.

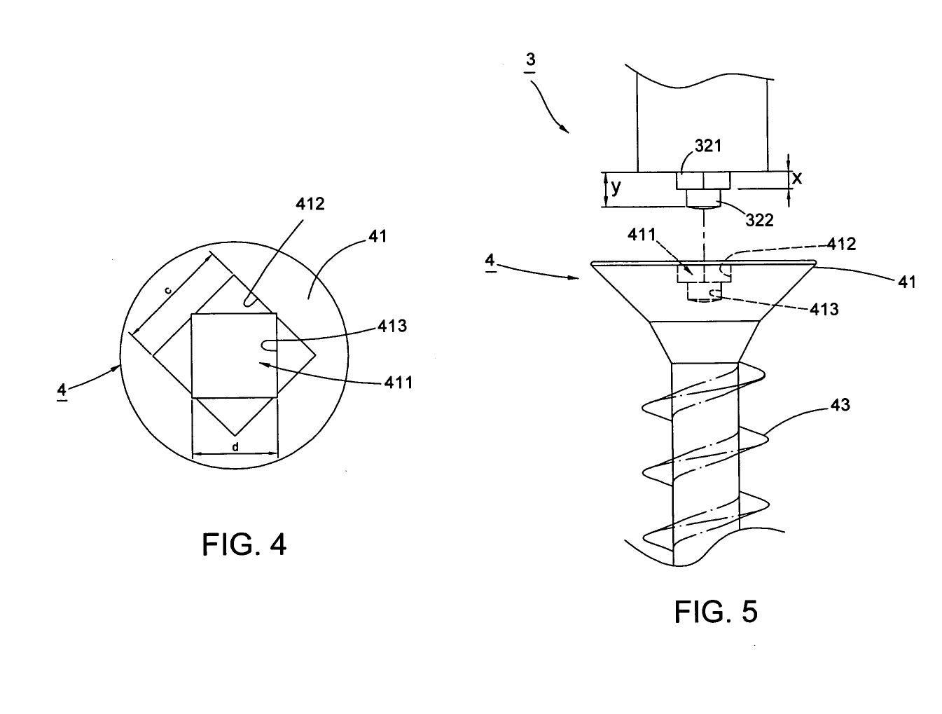

Further referring to FIGS. 3 and 4, the recessed screw 4 punched by the punch 3 comprises a screw head 41, a shank 42 longitudinally extended from the screw head 41, and a plurality of threads 43 arranged on the shank 42; wherein, a socket 411 is punched in the screw head 41 by the punch 3 for receiving a screwdriver; the socket 411 consists of a first recess 412 and a second recess 413; further, the first recess 412 and the second recess 413 separately have two series of square sides “c” and “d” defined around the peripheries thereof, which are in different widths. Since the punch head 32 punches to the screw 4, the recesses 412 and 413 of the socket 411 are simultaneous formed in dual tiers corresponding to the configurations of the square portions 321 and 322. Precisely, each of the series of square sides “c” of the first recess 412 equals to each of the series of square sides “a” of the first square portion 321, and each of the series of square sides “d” of the second recess 413 equals to each of the series of square sides “b” of the second square portion 322,

Still further, referring to FIGS. 3 to 5, the punch 3 initially punches a socket 411 in the screw head 41 of the screw 4, and the first recess 412 and the second recess 413 are accordingly formed in the socket 411 in accordance to the configuration of the first square portion 321 and the second square portion 322. According to the configurations that the first square portion 321 comprises the larger series of square sides “a” and the shorter height “x” than those of the second square portion 322 and is inclined with respect to the second square portion 322 by the included angle “θ”, thus dual tiers of recesses 412 and 413 are accordingly formed in the socket 411 with different series of square sides “c” and “d”. Subsequently, a plurality of threads 43 is formed on the shank 42, and further an integral recessed screw 4 is presented in FIG. 3.

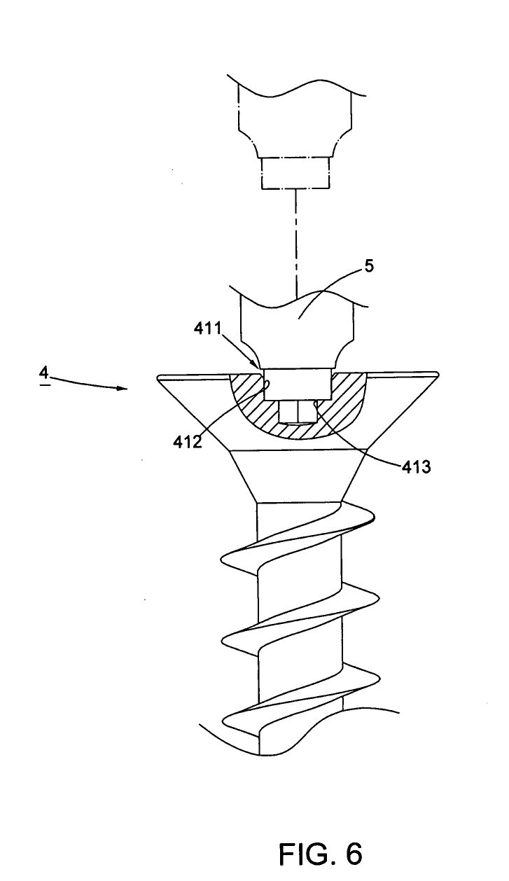

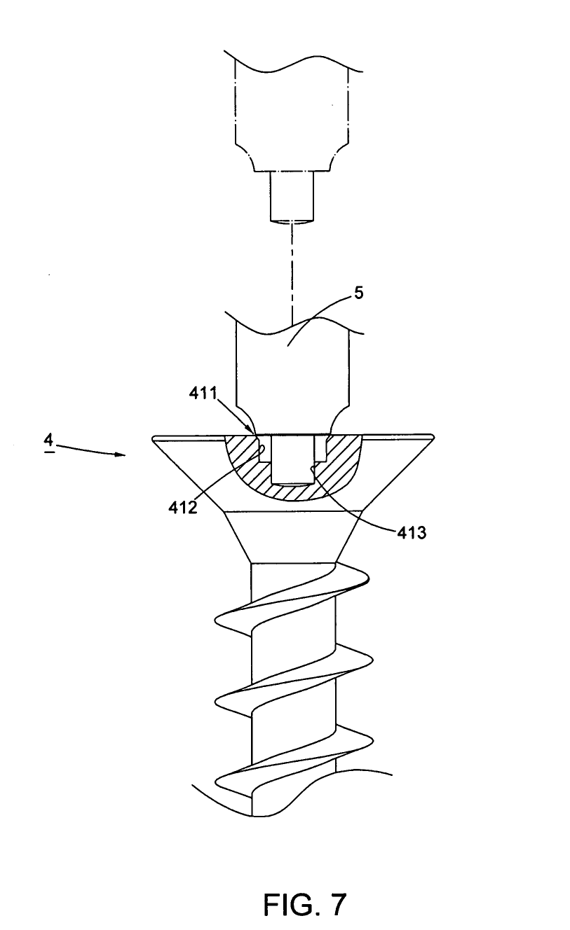

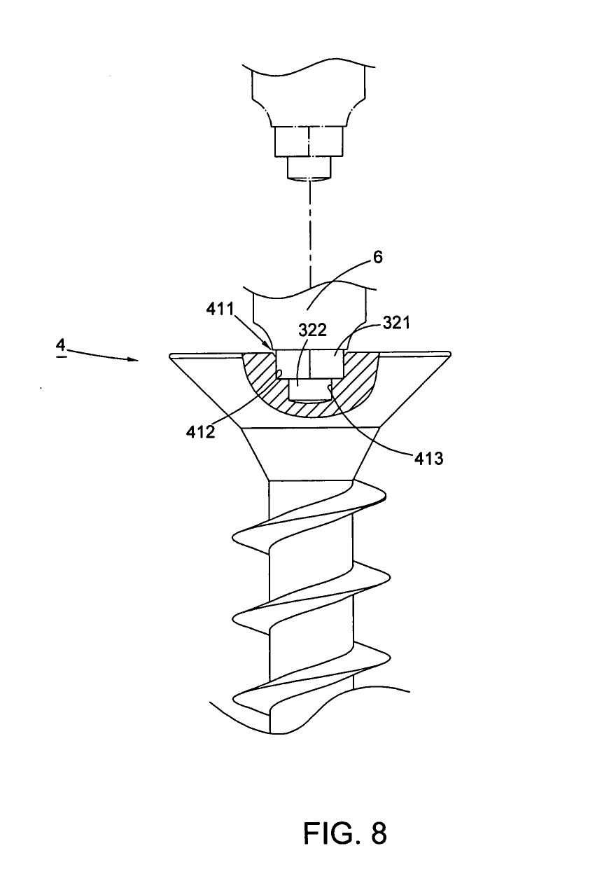

By means of the different dimensions of the recess 412 and 413, the screwdrivers 5 and 6 with various configurations can fit with the socket 411. That is, the screwdrivers 5 and 6 as shown in sequence in FIG. 6, FIG. 7, and FIG. 8 alternatively provide with the shapes corresponding to the shape of the first recess 412, of the second recess 413, or of the configuration of the square portions 321 and 322, so as to accurately fit with the different dimensions of the socket 411 to drive the screw 4.

Starting with FIG. 6, the screwdriver 5 is initially arranged as a square shape in conformity of the shape of the first recess 412, which results in the screwdriver 5 to be facilely and accurately drive into the first recess 412 of the socket 411. Similarly, the screwdriver 5 as illustrated in FIG. 7 presents a square shape in conformity of the shape of the second recess 413, thus improving the problem of the inadequate screwdriver 5 and increase the convenience while screwing.

Further referring to FIG. 8, the screwdriver 6 comprises a uniform shape as the configurations of the first square portions 321 and the second square portion 322, and the screwdriver 6 thus entirely and accurately fits with the socket 411, which facilitates to transfer a force on the screw 4 and prevent the screwdriver 6 from being facilely out of the socket 411 while driving the screw 4.

To sum up, the present invention notably takes advantage of the square portions of the punch for punching a socket in the screw head, which results in forming dual tiers of the recess with different dimensions therein. Thus, the recessed screw receives a screwdriver presenting a square shape or a configuration as the same as the punch head, thereby reducing the problem of unfitted driving tool and increasing the convenience of the operation.

While we have shown and described the present invention with reference to the specific preferred embodiment, it should be clear to those skilled in the art that further embodiments may be made without departing from the scope of the present invention.

I claim:

1. A punch for forming recessed screw head comprising:
a punch body; and
a punch head longitudinally extended from said punch body;
wherein, said punch body comprising a first square portion and a second square portion disposed on said first square portion;
said first square portion being inclined with respect to said second square portion by an included angle; said first square portion and said second square portion respectively having heights extended from the punch body and having two series of square sides defined around peripheries thereof; said height of said second square portion exceeding said height of said first square portion; each of said series of square sides of said first square portion being greater than each of said series of square sides of said second square portion.

2. A recessed screw punched by said punch of claim 1 comprising:
a screw head;
a shank longitudinally extended from said screw head; and
a plurality of threads arranged on said shank;
wherein, a socket being punched by said punch of claim 1 and defined in said screw head; said socket consisting of a first recess and a second recess, which are shaped corresponding to the configurations of said first square portion and said second square portion.

3. The punch for forming recessed screw head as claimed in claim 1, wherein said included angle is in 45 degrees.
